(19) United States
(12) Patent Application Publication
(10) Pub. No.: US 2026/0266296 A1
(43) Pub. Date: Sep. 10, 2026

(54) COMPRESSOR SUCTION INLET VANES WITH INTERMEDIATE DISCHARGE

(71) Applicant: TRANE INTERNATIONAL INC., Davidson, NC (US)

(72) Inventor: Bonaventure Ryan Nunes, Burnsville, MN (US)

(21) Appl. No.: 19/072,284

(22) Filed: Mar. 6, 2025

(51) Int. Cl. F04D 17/10; F04D 25/06; F04D 29/44; F25B 31/02

(52) U.S. Cl. CPC F04D 17/10; F04D 25/06; F04D 29/441; F25B 31/026; F25B 2400/0409

(57) ABSTRACT

A compressor includes a housing, an impeller, and inlet vanes disposed between a suction inlet of the housing and the impeller. The impeller rotates relative to the housing to compress suction working fluid from the suction inlet and intermediate working fluid from the intermediate inlet. The inlet vanes guide the suction working fluid flowing from the suction inlet to the impeller. One or more of the inlet vanes are configured to discharge the intermediate working fluid into the suction working fluid flowing across the inlet vanes. A heating, ventilation, air conditioning, and refrigeration (HVACR) system includes a refrigerant circuit with a compressor, a condenser, an expander, and an evaporator fluidly connected. A method of operating a compressor includes discharging intermediate working fluid from one or more inlet vanes into a flow of suction working fluid flowing across the inlet guide vanes.

### FIELD

This disclosure relates to inlet vanes in centrifugal compressors. More specifically, this disclosure relates to inlet vanes in a suction stream of a centrifugal compressor in heating, ventilation, air conditioning, and refrigeration (HVACR) systems.

### BACKGROUND

Heating, ventilation, air conditioning, and refrigeration (HVACR) systems are generally used to heat, cool, and/or ventilate an enclosed space (e.g., an interior space of a commercial building or a residential building, an interior space of a refrigerated transport unit, or the like). A HVACR system may include a refrigerant circuit for providing cooled or heated air to the area. The refrigerant utilizes a working fluid to cool or heat the air directly or indirectly. Generally, a refrigerant circuit includes a compressor for compressing the working fluid. The compressor receives and compresses a first flow of working fluid (e.g., a main flow from an evaporator in the refrigerant circuit. In some configurations, the refrigerant circuit also supplies a second flow of working fluid to the compressor (e.g., an intermediate flow that bypasses the evaporator). The flows of working fluid mix together and a compressed within the compressor. In some configurations, a compressor can include inlet vanes that guide the working fluid as it flow to an impeller of the compressor.

### SUMMARY

In an embodiment, a compressor is for a heating, ventilation, air conditioning, and refrigeration (HVACR) system. The compressor includes a housing, an impeller disposed within the housing, and inlet vanes disposed between the suction inlet and the impeller. The housing includes a suction inlet and an intermediate inlet. The impeller is configured to rotate relative to the housing to compress working fluid. The working fluid includes suction working fluid from the suction inlet and intermediate working fluid from the intermediate inlet. The inlet vanes are configured to guide the suction working fluid flowing from the suction inlet to the impeller. One or more of the inlet vanes are fluidly connected to the intermediate inlet and are configured to discharge the intermediate working fluid into the suction working fluid flowing across the inlet vanes.

In an embodiment, the one or more of the inlet vanes include a vane body with an inlet and one or more openings. The inlet is configured to receive the intermediate working fluid from the intermediate inlet. The one or more openings are configured to discharge the intermediate working fluid into the suction working fluid flowing across the inlet vanes.

In an embodiment, the vane body includes a downstream vane end and an upstream vane end opposite to the downstream vane end. The suction working fluid flows across the vane body from the upstream vane end to the downstream vane end. The one or more openings are formed in the downstream vane end of the vane body.

In an embodiment, the impeller includes an inlet configured to receive a mixed flow of the suction working fluid and the intermediate working fluid. The working fluid compressed by the impeller is discharged from the compressor through a discharge outlet in the housing.

In an embodiment, the compressor includes an electric motor disposed in a motor volume of the housing and configured to rotate the impeller. The intermediate inlet is fluidly connected to the one or more of the inlet vanes via the motor volume. The motor volume is configured to direct the intermediate working fluid in the motor volume across the electric motor to cool the electric motor.

In an embodiment, the compressor includes an intermediate passageway fluidly connecting the motor volume to the inlet vanes. The intermediate passageway is configured to direct the intermediate working fluid in the motor volume, after passing across the electric motor, to the one or more of the inlet vanes.

In an embodiment, the compressor includes a suction passageway that fluidly connects the suction inlet to an inlet of the impeller. The inlet vanes are disposed in the suction passageway and are configured to guide flow of the suction working fluid within the suction passageway.

In an embodiment, the inlet vanes are adjustable to change an angle of the inlet vanes within the suction passageway.

In an embodiment, the intermediate working fluid flows into the suction passageway through the one or more of the inlet vanes.

In an embodiment, a heating, ventilation, air conditioning, and refrigeration (HVACR) system includes a refrigerant circuit. The refrigerant circuit includes a compressor, a condenser, an expander, and an evaporator fluidly connected. The compressor includes a housing, an impeller disposed within the housing, and inlet vanes disposed between the suction inlet and the impeller. The housing includes a suction inlet and an intermediate inlet. The impeller is configured to rotate relative to the housing to compress working fluid. The working fluid includes suction working fluid from the suction inlet and intermediate working fluid from the intermediate inlet. The inlet vanes are configured to guide the suction working fluid flowing from the suction inlet to the impeller. One or more of the inlet vanes are fluidly connected to the intermediate inlet and are configured to discharge the intermediate working fluid into the suction working fluid flowing across the inlet vanes.

In an embodiment, the one or more of the inlet vanes includes a vane body with an inlet and one or more openings. The inlet is configured to receive the intermediate working fluid from the intermediate inlet. The one or more openings are configured to discharge the intermediate working fluid into the suction working fluid flowing across the inlet vanes.

In an embodiment, the vane body includes a downstream vane end and an upstream vane end opposite to the downstream vane end. The suction working fluid flows across the vane body from the upstream vane end to the downstream vane end. The one or more openings are formed in the downstream vane end of the vane body.

In an embodiment, the impeller includes an inlet configured to receive a mixed flow of the suction working fluid and the intermediate working fluid. The working fluid compressed by the impeller is discharged from the compressor through a discharge outlet in the housing.

In an embodiment, the compressor includes an electric motor disposed in a motor volume of the housing and configured to rotate the impeller. The intermediate inlet is fluidly connected to the one or more of the inlet vanes via the motor volume. The motor volume is configured to direct the intermediate working fluid in the motor volume across the electric motor to cool the electric motor.

In an embodiment, the compressor includes an intermediate passageway fluidly connecting the motor volume to the inlet vanes. The intermediate passageway is configured to direct the intermediate working fluid in the motor volume, after passing across the electric motor, to the one or more of the inlet vanes.

In an embodiment, the compressor includes a suction passageway that fluidly connects the suction inlet to an inlet of the impeller. The inlet vanes are disposed in the suction passageway and are configured to guide flow of the suction working fluid within the suction passageway.

In an embodiment, the inlet vanes are adjustable to change an angle of the inlet vanes within the suction passageway.

In an embodiment, the intermediate working fluid flows into the suction passageway through the one or more of the inlet vanes.

In an embodiment, the refrigerant circuit includes a main flow path and an intermediate flow path. The main flow path extends from the compressor, through the condenser, the expander, and the evaporator, and the compressor. The main flow path supplies the suction working fluid to the suction inlet of the compressor. The intermediate flow path extends from the main flow path to the intermediate inlet of the compressor. The intermediate flow path supplying the intermediate working fluid to the intermediate inlet of the compressor.

A method is directed to operating a compressor. The method includes suctioning a stream of suction working fluid from a suction inlet to an inlet of an impeller. The suctioning of the suction working fluid includes guiding, with inlet vanes, the flow of suction working fluid flowing from the suction inlet to the inlet of the compressor. The method also includes directing intermediate working fluid from an intermediate inlet to the inlet vanes, and discharging intermediate working fluid from one or more of the inlet vanes into the flow of suction working fluid flowing across the inlet vanes.

### DRAWINGS

FIG. 1 illustrates a schematic diagram of an embodiment of a refrigerant circuit in a heating, ventilation, air conditioning, and refrigeration (HVACR) system.

FIG. 2 illustrates a side sectional view of an embodiment of a centrifugal compressor.

FIG. 3 illustrates an enlarged view of a portion of the side sectional view of the compressor in FIG. 2.

FIG. 4 illustrates a block flow diagram of an embodiment of a method of operating a compressor in a refrigerant circuit of an HVACR system.

Like numbers represent like features.

### DETAILED DESCRIPTION

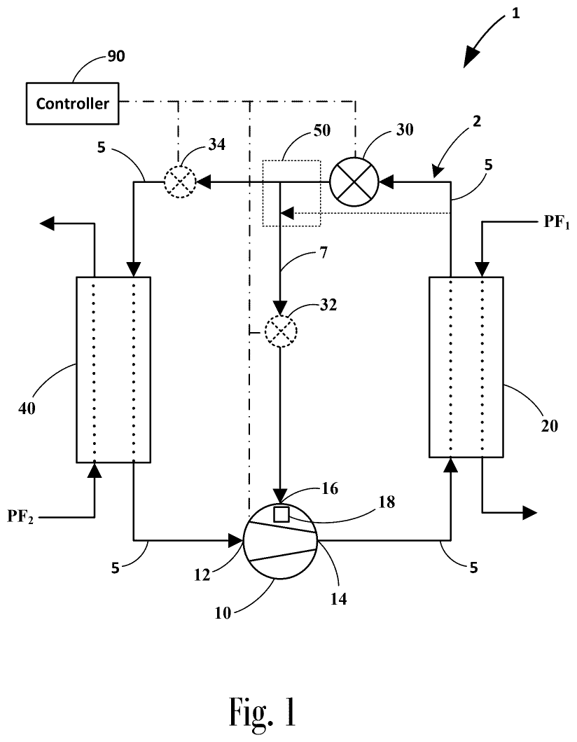

FIG. 1 is a schematic diagram of an embodiment of a refrigerant circuit 5 in a heating, ventilation, air conditioning, and refrigeration (HVACR) system 1. In an embodiment, the HVACR system 1 may be an industrial, commercial, or residential HVACR system 1 configured to condition the inside of a building (e.g., office space, residential house, or the like). In an embodiment, the HVACR system 1 may be a transport HVACR used for cooling the inside of a transport unit (e.g., shipping container, transport/trucking container, reefer, or the like) and/or a passenger vehicle (e.g., a bus, a plane, or the like).

The refrigerant circuit 5 includes a compressor 10, a condenser 20, an expansion device 30 (i.e., a first expansion device 30), and an evaporator 40 that are fluidly connected. In an embodiment, the refrigerant circuit 5 can be modified to include additional components. For example, the refrigerant circuit 5 in an embodiment can include one or more flow control devices, a receiver tank, a dryer, a suction-liquid heat exchanger, or the like. The components of the refrigerant circuit 5 are fluidly connected. Dotted lines are provided in FIG. 1 to indicate fluid flows through some components (e.g., condenser 20, evaporator 40) for clarity, and should be understood as not specifying a specific route within each component. Short dashed lines are used to indicate features that may be different in other embodiments. It should be appreciated that differences are not limited to the indicated features, and embodiments may have differences from the indicated features.

The refrigerant circuit 5 can be configured as a cooling system (e.g., a fluid chiller of an HVACR, an air conditioning system, or the like) that can be operated in a cooling mode, and/or the refrigerant circuit 5 can be configured to operate as a heat pump system that can run in a cooling mode and a heating mode.

The refrigerant circuit 5 applies known principles of gas compression and heat transfer. The refrigerant circuit 5 can be configured to heat or cool a process fluid (e.g., water, air, chiller fluid, or the like). In an embodiment, the refrigerant circuit 5 may represent a chiller that cools a process fluid such as water or the like. In an embodiment, the refrigerant circuit 5 may represent an air conditioner and/or a heat pump that cools and/or heats a process fluid such as air, water, or the like.

A working fluid flows through the refrigerant circuit 2. A flow path 5 of the working fluid through the refrigerant circuit 2 extends from the compressor 10 through the condenser 30, the expansion device 30, the evaporator 40, and back to the compressor 10. The working fluid includes one or more refrigerants (e.g., a single refrigerant, a refrigerant blend) and may include one or more additional components (e.g., lubricant(s), stabilizer(s), tracer(s), and the like). The flow path 5 can also be referred to as the main flow path of the refrigerant circuit 2. As shown in FIG. 1, the refrigerant circuit 2 also includes an intermediate flow path 7 that extends from and back to the main flow path 5. The intermediate flow path 7 extends back to the main flow path 5 within the compressor 10. The intermediate flow path 7 may also be referred to as a bypass flow path, as the intermediate flow path directs working fluid to bypasses the evaporator 40. The intermediate flow path 7 is described in more detail below.

During the operation of the refrigerant circuit 5, the working fluid flows into the compressor 10 from the evaporator 40 in a gaseous state at a relatively lower pressure. The compressor 10 compresses the gaseous working fluid into a high pressure state, which also heats the gas. The compressor 10 includes a suction inlet 12, a discharge outlet 14, an intermediate inlet 16 (e.g., a second inlet), and a compression mechanism configured to move within the compressor 10 to compress the gas into the high pressure state. A stream/flow of the lower pressure gaseous working fluid (which may be referred to as suction working fluid) flows from the evaporator 40 into the suction inlet 12 of the compressor 10 and is discharged from the discharge outlet 14 of the compressor 10 after being compressed by the compression mechanism. A different flow of working fluid (which may be referred to as intermediate working fluid) also flows to and into the compressor 10 through the intermediate inlet 16. The intermediate working fluid is mixed with the suction working fluid and is compressed with then and discharged from the compressor 10 with the suction working fluid. The intermediate inlet 16 is discussed in more detail below.

After being compressed, the relatively higher pressure and higher temperature gaseous working fluid flows from the discharge outlet 14 of the compressor 10 to the condenser 20. The working fluid flows through the condenser 20. In addition to the working fluid flowing through the condenser 20, a first process fluid PF₁ (e.g., external air, external water, cooling/heater water, glycol, combinations thereof, or the like) also separately flows through the condenser 20. The first process fluid PF₁ absorbs heat from the working fluid as the first process fluid PF₁ flows through the condenser 20, which cools the working fluid as the working fluid flows through the condenser 20. The working fluid condenses to liquid within the condenser 20. The liquid working fluid then flows from the condenser 20 to the expansion device 30.

The relatively cooler, relatively higher pressure liquid working fluid discharged from the condenser 20 flows from the condenser 20 into the expansion device 30. The expansion device (e.g., expansion device 30, expansion device 32, expansion device 34) is configured to allow the working fluid to expand, which converts the working fluid to a mixed vapor and liquid state. This expansion also causes further cooling of the working fluid. An “expansion device” as described herein may also be referred to as an expander. In an embodiment, the expander may be an expansion valve, expansion plate, expansion vessel, orifice, or the like, or other such types of expansion mechanisms. It should be appreciated that the expander may be any type of expansion device used in the field for expanding a working fluid to cause the gaseous working fluid to decrease in pressure and temperature.

A portion of the further relatively lower temperature, vapor/liquid working fluid (e.g., a first portion of the working fluid, a first portion of the expanded working fluid) flows from the expander 30 into the evaporator 40. A second process fluid PF₂ (e.g., air, chiller liquid, water, glycol, combinations thereof, or the like) also flows through the evaporator 40. The working fluid absorbs heat from the second process fluid PF₂ as it flows through the evaporator 40, which cools the second process fluid PF₂ as it flows through the evaporator 40. As the working fluid absorbs heat, the working fluid evaporates to vapor. The gaseous/mostly gaseous working fluid then returns to the compressor 10 from the evaporator 40. This portion of working fluid supplied to the suction inlet 12 of the compressor 10 can be referred to as a first stream of working fluid to the compressor 10.

The intermediate flow path 7 directs another portion of the working fluid discharged from the condenser 20 (e.g., a second portion of the working fluid) to the intermediate inlet 16 of the compressor 10. This portion of the working fluid may bypass the evaporator 40. This portion of the working fluid directed through the intermediate flow path 7 may also be referred to as a second flow of working fluid supplied to the compressor 10.

In the illustrated embodiment, the intermediate flow path 7 is configured to supply a portion of the expanded working fluid (e.g., working fluid after passing through the expander 30) to the intermediate inlet 16 of the compressor 10. It should be appreciated that in other embodiments, the intermediate flow path 7 may have an inlet that supplies a portion of the cooled working fluid (e.g., condensed working fluid discharged from the condenser 20, a portion of the working fluid prior to flowing through the expander 30) to the intermediate inlet 16 of the compressor 10. In an embodiment, the intermediate flow path 7 may include a second expander 32 that expands the working fluid flowing through the intermediate flow path 7. In the illustrated embodiment, the second expander 32 is provided in the intermediate flow path 7 in parallel with the first expander 30.

In an embodiment, the first expander 30 and a second expander 36 may be provided in series between the condenser 30 and the evaporator 40. The intermediate flow path 7 can then supply the second portion of the working fluid from the working fluid flowing from the first expander 30 to the second expander 32 (e.g., a portion of the partially expanded working fluid) to the intermediate inlet 16 of the compressor. In such an embodiment, the intermediate flow path 7 may or many not include a third expander (e.g., expander 34).

In an embodiment, the refrigerant circuit 5 may include an economizer heat exchanger 50 that is configured to cool the second portion of the working fluid supplied to the compressor 10 using the expanded first portion of the working fluid. For example, the second portion of the working fluid can bypass flow from the condenser 20 into the intermediate flow path 7 bypassing the first expander 30 (shown in a dashed arrow in FIG. 1). The economizer heat exchanger 50 cools the second portion of the working fluid with the expanded first portion of the working fluid. The second expander 32 may than expand the cooled second portion of the working fluid in the intermediate flow path 7 from the economizer heat exchanger 50 to the compressor 10.

In an embodiment, an expanders 30, 32, 34 can be an adjustable type of expansion device. For example, the expanders 30, 32 may each be an expansion valve. For example, one or both of the expanders 30, 32 may be adjusted to control the amount of the working fluid that will flow into the suction inlet 12 and the intermediate inlet 16 of the compressor.

The above-described process continues while the refrigerant circuit 5 is operated, for example, in a cooling mode. In an embodiment, the HVACR system 1 may include a controller (not shown) that controls operation of the one or more expanders 30, 32. The controller may control the expanders 30, 32 (e.g., the degree each expansion valve is open) so that the desired amount (e.g., percentage, or the like) of the working fluid discharged from the condenser flows through the first expander 30 and the second expander 32.

The compressor 10 is configured to supply the intermediate working fluid to the suction inlet flow within the compressor 10. The intermediate working fluid mixes with the inlet working fluid prior to compression (e.g., prior to reaching the compression mechanism, upstream of the compression mechanism, or the like). In an embodiment, the compressor 10 may be configured to supply the intermediate working fluid to the motor 18, then from the motor 18 to the suction inlet flow. For example, in such an embodiment, the compressor 10 can be configured to utilize the intermediate working fluid to provide cooling of the motor 18. In another embodiment, the compressor 10 may be configured to directly supply the intermediate working fluid to the suction inlet flow (e.g., not provided from the motor 18). For example, in such an embodiment, the compressor 10 can be configured to directly supply the intermediate working fluid to the suction inlet flow to improve performance of the compressor 10 and/or the refrigerant circuit 5 (e.g., improve capacity of the refrigerant circuit 5, increase efficiency of the compressor 10, or the like).

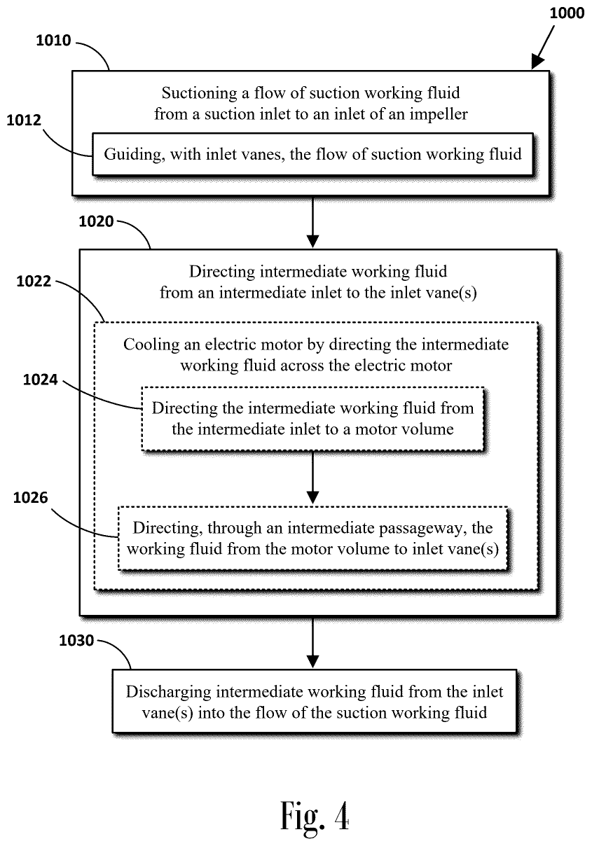

The refrigerant circuit 2 includes a controller 90 for controlling operation of refrigerant circuit 2 and its components. In an embodiment, the controller 90 may be the controller of the HVACR system 1. In an embodiment, the controller 90 may be the controller of the compressor 10. In an embodiment, the controller 90 includes memory (not shown) for storing information and a processor (not shown). The control schemes, operations, and information relevant to such control schemes and operations for the refrigerant circuit 2 and its components (e.g., the compressor 10, expander 30, expander 32, expander 34) as described herein may be stored on the memory 91A. For example, the operations described below for method 1000 in FIG. 4 may be stored on the controller 90. The controller 90 in FIG. 1 and described below is described/shown as a single component. However, it should be appreciated that a “controller” as shown in the Figures and described herein may include multiple discrete or interconnected components that include the memory 91A and a processor 91B in an embodiment.

Dashed and dotted lines are provided in the Figures to illustrate electronic communications between different features. For example, dashed and dotted lines are provided between the controller 90 and different components of the refrigerant circuit 2 that are used, controlled, and the like by the controller 90. For example, a dashed dotted line extends from the controller 90 to the compressor 10 as the controller 90 can be configured to control operation the compressor 10 (e.g., control speed of the motor 18, adjust position of inlet vanes of the compressor, or the like). For example, a dashed dotted line(s) extend from the controller 90 to the expansion valve(s) 30, 32, 34 as the controller 90 can be configured to control operation of the expansion valve(s) 30, 32, 34 (e.g., to control degree open of each expansion valve). The refrigerant circuit 5 may include one or more sensors (e.g., temperature sensors, pressure sensors, flow sensors, or the like) (not shown) used by the controller 90 for detecting one or more properties of the working fluid in the refrigerant circuit 2. For example, the controller 190 may control the expansion valve(s) 30, 32, 34 based on the detected properties of the working fluid. For example, the controller 90 may be configured to control an amount of the working fluid directed into and through intermediate flow path into the intermediate inlet 16 of the compressor 10.

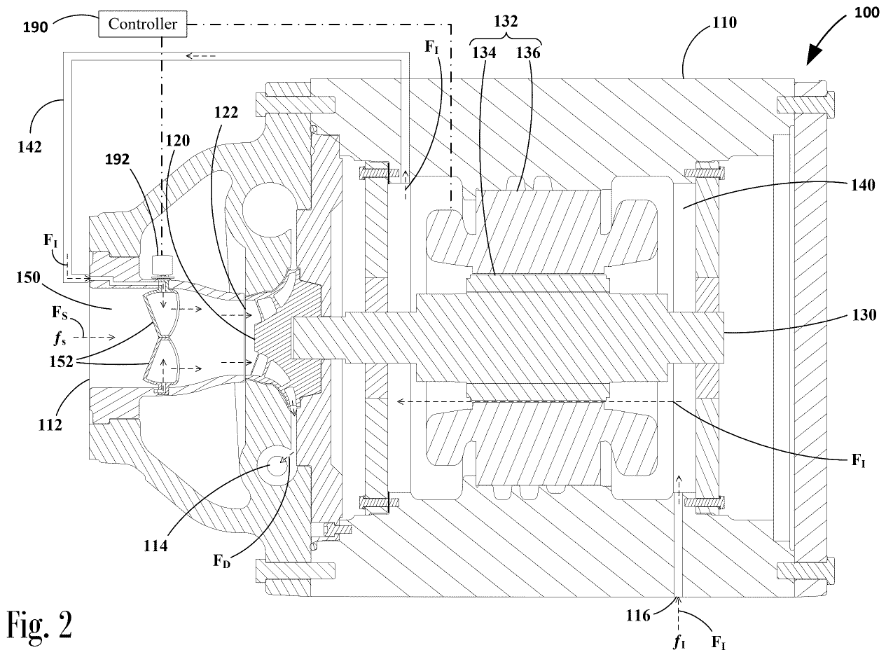

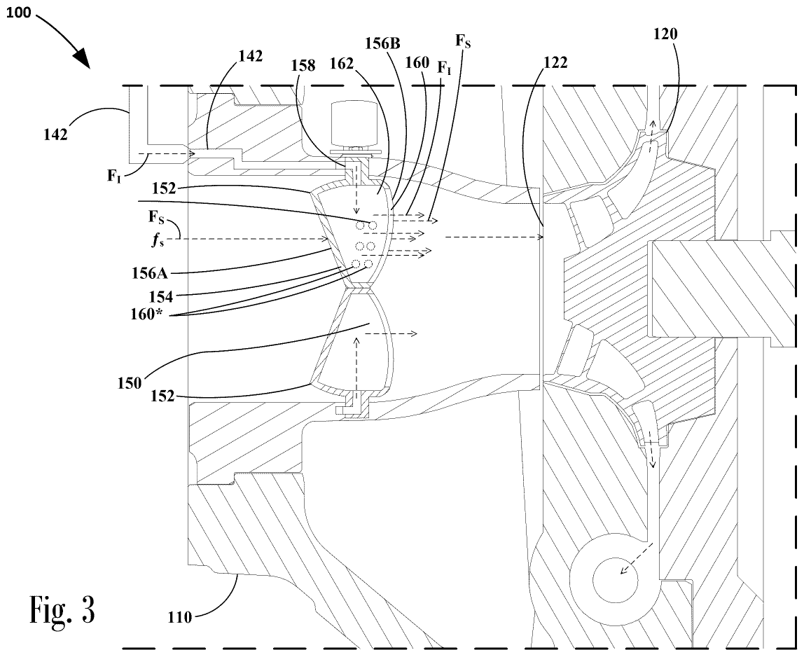

FIG. 2 is a side sectional view of an embodiment of a centrifugal compressor 100. The centrifugal compressor 100 is configured to compressor working fluid in a refrigerant circuit of an HVACR system. For example, the centrifugal compressor 100 in an embodiment may be the compressor 10 in the refrigerant circuit 5 of the HVACR system 1 in FIG. 1. Dashed arrows are used in FIGS. 2 and 3 to indicate flows of working fluid within the compressor 100.

The centrifugal compressor 100 includes a compressor housing 110. For example, the compressor housing 110 is the outermost housing of the compressor 100. The compressor housing 110 may also be referred to a housing 110. The compressor 100 includes an impeller 120 that rotates (e.g., relative to the housing 110) to compress working fluid. The compressor 100 includes a driveshaft 130 and an electric motor 132 for rotating the impeller 120. The impeller 120 is rotated by the electric motor 132 via the driveshaft 130. The impeller 120 is affixed to the driveshaft 130 (e.g., affixed to an end of the driveshaft 130). The electric motor 132 rotates the driveshaft 130 which rotates the impeller 120 affixed thereto. The electric motor 132 may operate according to known principles to rotate the driveshaft 130. For example, the electric motor 132 can include a rotor 134 affixed to the driveshaft 130 such that they rotate together (e.g., the rotor 134 and the driveshaft 130 can be affixed together using an interference fit or other type of fit) and a stator 136 that generates an electric field that causes rotation of the rotor 134 (and the driveshaft 130 affixed thereto).

The compressor 100 includes a suction inlet 112 (e.g., a first working fluid inlet), a discharge outlet 114, and an intermediate inlet 116 (e.g., a second working fluid inlet). As shown in FIG. 2, the suction inlet 112, the discharge outlet 114, an intermediate inlet 116 are each a respective port formed in the housing 110. A first stream of working fluid fₛ flows into the compressor 100 through the suction inlet 112 and a second stream of working fluid fᵢ flows into the compressor 100 through the intermediate inlet 116. The working fluid in the first stream fₛ may be referred to as suction working fluid F_{S} and the working fluid in the second stream fᵢ may be referred to as intermediate working fluid F_{I}. The working fluid (e.g., suction working fluid F_{S} and the intermediate working fluid F_{I}) is compressed within the compressor 100 and the compressed working fluid F_{D} is discharged from the compressor 100 through the discharge outlet 114. For example, working fluid (e.g., suction working fluid F_{S} and intermediate working fluid F_{I}) is suctioned to the impeller 120, is compressed as it flows through the impeller 120 (i.e., is compressed by the impeller 120), and the compressed working fluid F_{D} flows from the impeller 120 to the discharge outlet 114.

The compressor 100 includes a suction passageway 150 that fluidly connects the suction inlet 112 to the impeller 120 (e.g., to the inlet 122 of the impeller 120). For example, the suction passageway 150 directs the suction working fluid F_{S} from the suction inlet 112 to the impeller 120 (e.g., directs the suction working fluid F_{S} from the suction inlet 112 to an inlet 122 of the impeller 120).

The compressor 100 includes inlet vanes 152 configured to guide the flow of working fluid into the impeller 120. For example, the inlet vanes 152 can be configured to control swirl (e.g., reduce swirl, reduce circumferential currents) in the working fluid flowing into the impeller 120. The inlet vanes 152 are disposed downstream of the suction inlet 112 and upstream of the impeller 120 within the compressor 100. As shown in the illustrated embodiment, the inlet vanes 152 can be disposed in the suction passageway 150 of the compressor 100. Inlet vanes 152 can also be referred to as inlet guide vanes.

In the compressor 100, the intermediate inlet 116 is fluidly connected to the inlet vanes 152. The intermediate working fluid F_{I} is supplied from the intermediate inlet 116 to the impeller 120 (e.g., to the inlet 122 of the impeller 120) through the inlet vanes 152. The intermediate working fluid F_{I} is discharged from the inlet vanes 152 and flows from the inlet vanes 152 to the impeller 120. The intermediate working fluid F_{I} is discharged from the inlet vanes 152 into the suction passageway 150. The intermediate working fluid F_{I} flows from the inlet vanes 152 to the impeller (e.g., to the inlet 122 of the impeller 120).

As shown in FIG. 2, the housing 110 includes an internal volume containing the motor 132. In particular, the housing 110 includes a motor volume 140 and the motor 132 is disposed in the motor volume 140. In the illustrated embodiment, intermediate working fluid F_{I} is supplied to the inlet vanes 152 via the motor volume 140. As shown in FIG. 2, the compressor 100 includes an intermediate passageway 142 fluidly connects the motor volume 140 to the inlet vanes 152. The intermediate inlet 116 connects to the motor volume 140. The intermediate inlet 116 directs intermediate working fluid F_{I} into the motor volume 140 (e.g., intermediate inlet 116 supplies intermediate working fluid F_{I} to the motor volume 140), and the intermediate passageway 142 directs the intermediate working fluid F_{I} from the motor volume 140 to the inlet vanes 152 (e.g., the intermediate passageway 142 supplies the intermediate working fluid F_{I} to the inlet vanes 152 from the motor volume 140).

The intermediate working fluid F_{I} flows from the intermediate inlet 116 into the motor volume 140, through the motor volume 140 to the intermediate passageway 142, and through the intermediate passageway 142 to the inlet vanes 152. The intermediate working fluid F_{I} flows across and the motor 132 and cools the motor 132 as it flows across the motor 132. For example, the intermediate working fluid F_{I} can cool the motor 132 as it flows through the motor 132 (e.g., through passageway(s) (not shown) that extend through the motor 132). The intermediate working fluid F_{I} absorbs heat from the motor 132 and is heated by the motor 132. The heated intermediate working fluid F_{I} then flows into the intermediate passageway 142. In the illustrated embodiment, a portion of the intermediate passage 142 extends outside the housing 110. In another embodiment, the entire intermediate passage 142 may be disposed in/within the housing 110 (e.g., the intermediate passage 142 may not extend external to the housing 110).

In another embodiment, the intermediate working fluid F_{I} may be directly supplied from the intermediate inlet 116 to the inlet vanes 152. The intermediate inlet 116 can be connected to the inlet vanes 152 without the motor volume 140. For example, the intermediate passageway 142 is directly connect the intermediate inlet 116 to the inlet vanes 152. In such an embodiment, the intermediate working fluid F_{I} can be directly supplied (e.g., without providing cooling to the motor 132) to improve performance of the compressor 100 and/or a refrigerant circuit of the compressor 100 (e.g., improve capacity of the refrigerant circuit, increase efficiency of the compressor, or the like).

The compressor 100 shown in FIG. 2 is a single stage compressor. It should be appreciated that the compressor 100 in other embodiments may be a multi-stage compressor that has multiple stages. In such an embodiment, the multiple stages may be continuous stages (e.g., multiple stages provided back-to-back, each stage directly feeding into the next stage) or separated stages (e.g., one or more separate stages provided at opposite ends of the driveshaft 130). In an embodiment, the inlet vanes for the impeller of one or more of the stages may have features as described for the inlet vanes 152 (e.g., configured to discharge a flow of intermediate working fluid into the suction stream of fluid flowing into the impeller of the respective stage). For example, the inlet vanes for the second stage may be configured to discharge working fluid into the suction stream flowing to the impeller of the respective stage. For example, the inlet vane of multiple stages (e.g., inlet vanes of the first stage and inlet vanes of second stage, inlet vanes of the second stage and inlet vanes of the third stage, or the like) may each be configured to a discharge a respective flow of intermediate working fluid into the suction stream flowing to the impeller of the respective stage. In such embodiments, the intermediate passageway 142 may fluidly connect to each set of said inlet vanes and supply a respective flow of intermediate working fluid to the inlet(s) of each of said inlet vanes.

As shown in FIG. 2, the compressor 100 can also include a controller 190. In an embodiment, the controller 190 may be the controller of the HVACR system of the compressor 100 (e.g., controller 90 in FIG. 1). The controller 190 can be configured to control operation of the compressor 100 and its components. For example, the controller 190 may be configured to control operation of the motor 132 of the compressor (e.g., to control a speed the motor 132). For example, the controller 190 can be configured to control operation of the inlet vanes 152 (e.g., adjust the angle of the inlet vanes, control a degree open of the inlet vanes 152). For example, the compressor 100 may include a vane motor 192 for rotating the guide vanes 152, the controller 190 can be configured to operate the vane motor 192 for the guide vanes 152 to adjust the guide vanes 152 (e.g., adjust the angle of the vanes, adjust a degree open of the vanes). The adjusting of the guide vanes 152 may be controlled in the same manner as generally known for inlet guide vanes of a compressor. Such control schemes for the guide vanes 152 may be modified to account for the discharge of the intermediate working fluid from the inlet vanes 152.

FIG. 3 is a partial side sectional view of the compressor 100 in FIG. 2, according to an embodiment. In particular, FIG. 3 shows an enlarged view of a portion of the side sectional view of the compressor 100 in FIG. 2.

As shown in FIG. 3, the suction working fluid F_{S} flows from the suction inlet 112 to impeller 120 through the suction passageway 150. The suction working fluid F_{S} in the suction passageway 150 flows over the inlet vanes 152 as it flows from the suction inlet 112 to the impeller 120. The inlet vanes 152 are configured to be adjustable to change the angle of each inlet vane 152 within the suction passageway 150. For example, the inlet vanes 152 are rotatable within the suction passageway 150 to change the angle of each inlet vane 152 (e.g., each inlet vane 152 is rotatable within the suction passageway 150). In the illustrated embodiment, the inlet vane(s) 152 are at or about 100% open (e.g., at or about parallel to the overall flow direction of the through the suction passageway 150, angled to limit circumferential flow vectors within the flowing suction working fluid F_{S}). Each inlet vane 152 can have an aerodynamic shape such as, but not limited to, a generally planar shape (e.g., a blade shape or the like), a chambered shape, and the like.

Inlet vane 152 include a vane body 154. Inlet vane 152 (e.g., vane body 154) has a first vane end 156A and a second vane end 156B opposite the first vane end 156A. The first vane end 156A is the upstream vane end and the second vane end 156B is the downstream vane end. The suction working fluid F_{S} flows across the inlet vane 152 (e.g., across the vane body 154) from the first vane end 156A to the second vane end 156B. For example, the upstream vane end (e.g., first vane end 156A) provides the leading edge of the inlet vane 152 that is configured to face into the flow of suction working fluid F_{S}. For example, the downstream vane end (e.g., second vane end 156B) provides the trailing edge of the inlet vane 152.

Inlet vane 152 includes an inlet 158 and one or more openings 160. For example, the inlet 158 and the opening(s) 160 are formed in the vane body 154. The vane body 154 can have a hollow structure through which the intermediate working fluid F_{I} flows. For example, the vane body 154 includes a chamber 162 (e.g., an enclosed chamber) that connects the inlet 158 to the opening(s) 160. Intermediate working fluid F_{I} enters the inlet vane 154 through the inlet 158 and is discharged through the openings 160.

In the inlet vane 152, the opening(s) 160 form the outlet(s) (e.g., in the vane body 154) through which the intermediate working fluid F_{I} is discharged into the suction passageway 150. The intermediate working fluid F_{I} enters the suction passageway 150 through the inlet vanes 152. The inlet vanes 152 are configured to discharge the intermediate working fluid F_{I} into the suction working fluid F_{S} flowing into the impeller 120 (e.g., into the inlet 122 of the impeller 120). Downstream of the inlet vanes 152, the intermediate working fluid F_{I} discharged from the inlet vanes 152 mixes with the suction working fluid F_{S}. The resulting mixed flow f_{M} of the intermediate working fluid F_{I} and the suction working fluid F_{S} flows into the impeller 120 (e.g., into the inlet 122 of the impeller 120). For example, the inlet 122 of the impeller 120 receives the mixed flow f_{M} of the suction working fluid F_{S} and the intermediate working fluid F_{I} from the suction passageway 150.

The opening(s) 160 are formed in the second vane end 156B of the inlet vane 152 (e.g., in the rear end of the inlet vane 152) so that the intermediate working fluid F_{I} is discharged from the opening(s) 160 at or about the same vector as the suction working fluid F_{S} flows along the inlet vane 152. For example, the opening(s) 160 in the inlet vanes 152 can be configured to discharge the intermediate working fluid F_{I} into the suction working fluid F_{S} at or about the same angle as the suction working fluid flows along the inlet vane 152.

The fluid flowing into an impeller can be in uneven flow due to currents in the flow (e.g., due to swirling, circumferential currents, and the like). The inlet vanes 152 are configured to help guide the working fluid and reduce circumferential movement in the flow of working flow into the impeller 120. The discharge of the intermediate working fluid F_{I} into the suction working fluid F_{S} through the inlet vanes 152 is configured to reduce any directional impact of mixing the intermediate working fluid F_{I} into the flow of the suction working fluid F_{S}. For example, the supplying the intermediate working fluid F_{I} via the inlet vanes 152 is configured to have a reduced directional impact on the mixed flow F_{M} flowing into the inlet 122 of the impeller 120. The supplying of the intermediate working fluid F_{I} via the inlet vanes 152 is configured to advantageously reduce/limit any increase of the swirl/circumferential currents in the working fluid (e.g., in the mixed flow F_{M}) flowing into the inlet 122 of the impeller 120.

In the illustrated embodiment, inlet vane 152 includes one opening 160. It should be appreciated that in other embodiments, the inlet vane 152 may have a plurality of the openings 160 (e.g., two openings, three openings, or the like). As shown in FIG. 3, the opening(s) 160 are formed in the second vane end 156B (e.g., in the downstream vane end). In the illustrated embodiment, the opening 160 is formed at the rear edge on the second vane end 156B.

It should be appreciated that in an embodiment, the inlet vane 152 may include one or more openings 160 at different locations/surfaces of the second vane end 156B than the rear edge. In an embodiment, one or more the opening(s) 160 in the sides of the inlet vane 152 (one side of each inlet vane 152 is shown in FIG. 3) (e.g., in the sides of the inlet vane 152 on the second vane end 156B). For example, in an embodiment, the inlet vane 152 may include openings 160* disposed in one or more sides of the inlet vane 152. The inlet vane 152 may be configured to discharge the intermediate working fluid into the suction working fluid while disposed along the inlet vane 152. The openings 160* can be configured (e.g., sized, angled, and the like) so that the intermediate working fluid is diffused from the inlet vane into the stream of suction working fluid flowing along the vane 152. For example, such “diffusion” is when the discharging of the intermediate working fluid into the suction working fluid without having a significant impact on the flow direction of the flow of suction working fluid (e.g., mixes the intermediate working fluid into the suction flow without significantly increasing swirl in the suction working fluid).

FIG. 4 is a block for diagram for an embodiment of a method 1000 for operating a compressor. The compressor is operated to compress working fluid in a refrigerant circuit of a HVACR circuit. For example, the method 1000 may be employed for operating the compressor 10 in the refrigerant circuit 2 of the HVACR system 1 in FIG. 1. For example, the method 1000 may be employed to operate the compressor 100 in FIG. 2-3. The method 1000 begins at 1010.

At 1010, a stream (e.g., first stream of working fluid f₁) of suction working fluid (suction working fluid F_{S}) is suctioned from a suction inlet (e.g., suction inlet 12, suction inlet 112) to an inlet (e.g., inlet 122) of an impeller (e.g., impeller 120). The compressor included the suction inlet, an intermediate inlet (e.g., intermediate inlet 16, intermediate inlet 116), and a discharge outlet (e.g., discharge outlet 14, discharge outlet 114). For example, the compressor includes a housing (e.g., housing 110) with the suction inlet, the intermediate inlet, and the discharge outlet.

For example, the impeller rotates to suction the suction working fluid into the suction inlet of the compressor, from the suction inlet to the impeller, compress the working fluid, and discharge the working fluid from the compressor through the discharge outlet.

The suctioning of the working fluid at 1010 includes at 1012, guiding, with inlet vanes (e.g., impeller 154), the flow of the suction working fluid flowing form the intermediate inlet to the impeller. In an embodiment, the guiding of suction working fluid with the inlet vanes 1012 can include adjusting the inlet vanes. The adjusting of inlet vanes can include rotating the inlet vanes relative to the housing. This adjusting of the inlet vanes can be adjusting a degree open of the inlet vanes (e.g., adjusting the inlet vanes to be more closed, opening the inlet vanes to be more open, adjusting the angle of the inlet vanes, or the like). The method 1000 then proceeds from 1010 to 1020.

At 1020, intermediate working fluid is directed from the intermediate inlet to one or more of the inlet vane(s). For example, an intermediate passageway (e.g., intermediate passageway 142) directs the intermediate working fluid from the intermediate inlet to the inlet vane(s). In an embodiment, the directing of the intermediate working fluid at 1020 can include at 1022, cooling an electric motor (e.g., motor 18, electric motor 132) by directing the intermediate working fluid across the electric motor. The intermediate working fluid is directed across the electric motor between the intermediate inlet and the inlet vane(s). For example, 1022 can include directing the intermediate working fluid from the intermediate inlet to a motor volume (e.g., motor volume 140) at 1024 and directing the intermediate working fluid from the motor volume to the inlet vane(s) at 1026. The intermediate working fluid flows across the motor to cool the motor as the intermediate working fluid flows through the motor volume. The method 1000 then proceeds from 1020 to 1030.

At 1030, the intermediate working fluid is discharged from the inlet vane(s) into the flow of the suction working fluid flowing across the inlet vanes. The intermediate working fluid is discharged into the flow of working fluid flowing from the suction inlet to the impeller.

It should be appreciated that the method 1000 in an embodiment may be modified to include features as discussed above and/or shown in FIG. 1 for the compressor 10 and/or to include features as discussed above and/or shown in FIGS. 2 and 3 for the compressor 100. For example, the method 1000 may include the impeller compressing a mixed stream that includes the suction working fluid and the intermediate working fluid and discharging the compressed working fluid through the discharge outlet of the compressor.

### Aspects

Any of Aspects 1-9 may be combined with any of Aspects 10-20, and any one of Aspects 10-19 may be combined with Aspect 20.
Aspect 1. A compressor for a heating, ventilation, air conditioning, and refrigeration (HVACR) system, the compressor comprising:
   a housing including a suction inlet and an intermediate inlet;
   an impeller disposed within the housing, the impeller configured to rotate relative to the housing to compress working fluid that includes suction working fluid from the suction inlet and intermediate working fluid from the intermediate inlet;
   inlet vanes disposed between the suction inlet and the impeller, the inlet vanes configured to guide the suction working fluid flowing from the suction inlet to the impeller, one or more of the inlet vanes fluidly connected to the intermediate inlet and configured to discharge the intermediate working fluid into the suction working fluid flowing across the inlet vanes.
Aspect 2. The compressor of Aspect 1, wherein the one or more of the inlet vanes includes a vane body having:
   an inlet configured to receive the intermediate working fluid from the intermediate inlet, and
   one or more openings configured to discharge the intermediate working fluid into the suction working fluid flowing across the inlet vanes.
Aspect 3. The compressor of Aspect 2, wherein the vane body includes a downstream vane end and an upstream vane end opposite to the downstream vane end, the suction working fluid flows across the vane body from the upstream vane end to the downstream vane end, and the one or more openings are formed in the downstream vane end of the vane body.
Aspect 4. The compressor of any one of Aspects 1-3, wherein the impeller includes an inlet configured to receive a mixed flow of the suction working fluid and the intermediate working fluid, and the working fluid compressed by the impeller is discharged from the compressor through a discharge outlet in the housing.
Aspect 5. the compressor of any one of aspects 1-4, further comprising:
   an electric motor configured to rotate the impeller, the electric motor disposed in a motor volume of the housing, the intermediate inlet being fluidly connected to the one or more of the inlet vanes via the motor volume, the motor volume configured to direct the intermediate working fluid in the motor volume across the electric motor to cool the electric motor.
Aspect 6. The compressor of Aspect 5, further comprising:
   an intermediate passageway fluidly connecting the motor volume to the inlet vanes, the intermediate passageway directing the intermediate working fluid in the motor volume, after passing across the electric motor, to the one or more of the inlet vanes.
Aspect 7. The compressor of any one of Aspects 1-6, further comprising:
   a suction passageway fluidly connecting the suction inlet to an inlet of the impeller, the inlet vanes disposed in the suction passageway and configured to guide flow of the suction working fluid within the suction passageway.
Aspect 8. The compressor of any one of Aspects 1-7, wherein the inlet vanes are adjustable to change an angle of the inlet vanes within the suction passageway.
Aspect 9. The compressor of any one of Aspects 1-8, wherein the intermediate working fluid flows into the suction passageway through the one or more of the inlet vanes.
Aspect 10. A heating, ventilation, air conditioning, and refrigeration (HVACR) system, comprising:
   a refrigerant circuit including a compressor, a condenser, an expander, and an evaporator fluidly connected, the compressor including:
      a housing including a suction inlet and an intermediate inlet,
      an impeller disposed within the housing, the impeller configured to rotate relative to the housing to compress working fluid that includes suction working fluid from the suction inlet and intermediate working fluid from the intermediate inlet,
      inlet vanes disposed between the suction inlet and the impeller, the inlet vanes configured to guide the suction working fluid flowing from the suction inlet to the impeller, one or more of the inlet vanes fluidly connected to the intermediate inlet and configured to discharge the intermediate working fluid into the suction working fluid flowing across the inlet vanes.
Aspect 11. The HVACR system of Aspect 10, wherein the one or more of the inlet vanes includes a vane body having:
   an inlet configured to receive the intermediate working fluid from the intermediate inlet, and
   one or more openings configured to discharge the intermediate working fluid into the suction working fluid flowing across the inlet vanes.
Aspect 12. The HVACR system of Aspect 11, wherein the vane body includes a downstream vane end and an upstream vane end opposite to the downstream vane end, the suction working fluid flows across the vane body from the upstream vane end to the downstream vane end, and the one or more openings are formed in the downstream vane end of the vane body.
Aspect 13. The HVACR system of any one of Aspects 10-12, wherein the impeller includes an inlet configured to receive a mixed flow of the suction working fluid and the intermediate working fluid, and the working fluid compressed by the impeller is discharged from the compressor through a discharge outlet in the housing.
Aspect 14. The HVACR system of any one of Aspects 10-13, wherein the compressor includes an electric motor configured to rotate the impeller, the electric motor disposed in a motor volume of the housing, the intermediate inlet being fluidly connected to the one or more of the inlet vanes via the motor volume, the motor volume configured to direct the intermediate working fluid in the motor volume across the electric motor to cool the electric motor.
Aspect 15. The HVACR system of Aspect 14, wherein the compressor includes an intermediate passageway fluidly connecting the motor volume to the inlet vanes, the intermediate passageway directing the intermediate working fluid in the motor volume, after passing across the electric motor, to the one or more of the inlet vanes.
Aspect 16. The HVACR system of any one of Aspects 10-15, wherein the compressor includes a suction passageway fluidly connecting the suction inlet to an inlet of the impeller, the inlet vanes disposed in the suction passageway and configured to guide a stream of the suction working fluid within the suction passageway.
Aspect 17. The HVACR system of Aspect 16, wherein the inlet vanes are adjustable to change an angle of the inlet vanes within the suction passageway.
Aspect 18. The HVACR system of Aspect 16, wherein the intermediate working fluid flows into the suction passageway through the one or more of the inlet vanes.
Aspect 19. The HVACR system of any one of Aspects 10-18, wherein the refrigerant circuit includes:
   a main flow path that extends from the compressor, through the condenser, the expander, and the evaporator, and the compressor, the main flow path supplying the suction working fluid to the suction inlet of the compressor, and
   an intermediate flow path extending from the main flow path to the intermediate inlet of the compressor, the intermediate flow path supplying the intermediate working fluid to the intermediate inlet of the compressor.
Aspect 20. A method of operating a compressor, comprising:
   suctioning a stream of suction working fluid from a suction inlet to an inlet of an impeller, which includes guiding, with inlet vanes, the flow of suction working fluid flowing from the suction inlet to the inlet of the compressor;
   directing intermediate working fluid from an intermediate inlet to the inlet vanes; and
   discharging intermediate working fluid from one or more of the inlet vanes into the flow of suction working fluid flowing across the inlet vanes.

The terminology used herein is intended to describe particular embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components. In an embodiment, “connected” and “connecting” as described herein can refer to being “directly connected” and “directly connecting”.

With regard to the preceding description, it is to be understood that changes may be made in detail, especially in matters of the construction materials employed and the shape, size, and arrangement of parts without departing from the scope of the present disclosure. This Specification and the embodiments described are exemplary only, with the true scope and spirit of the disclosure being indicated by the claims that follow.

What is claimed is:

1. A compressor for a heating, ventilation, air conditioning, and refrigeration (HVACR) system, the compressor comprising:
a housing including a suction inlet and an intermediate inlet;
an impeller disposed within the housing, the impeller configured to rotate relative to the housing to compress working fluid that includes suction working fluid from the suction inlet and intermediate working fluid from the intermediate inlet;
inlet vanes disposed between the suction inlet and the impeller, the inlet vanes configured to guide the suction working fluid flowing from the suction inlet to the impeller, one or more of the inlet vanes fluidly connected to the intermediate inlet and configured to discharge the intermediate working fluid into the suction working fluid flowing across the inlet vanes.

2. The compressor of claim 1, wherein the one or more of the inlet vanes includes a vane body having:
an inlet configured to receive the intermediate working fluid from the intermediate inlet, and
one or more openings configured to discharge the intermediate working fluid into the suction working fluid flowing across the inlet vanes.

3. The compressor of claim 2, wherein the vane body includes a downstream vane end and an upstream vane end opposite to the downstream vane end, the suction working fluid flows across the vane body from the upstream vane end to the downstream vane end, and the one or more openings are formed in the downstream vane end of the vane body.

4. The compressor of claim 1, wherein the impeller includes an inlet configured to receive a mixed flow of the suction working fluid and the intermediate working fluid, and the working fluid compressed by the impeller is discharged from the compressor through a discharge outlet in the housing.

5. The compressor of claim 1, further comprising:
an electric motor configured to rotate the impeller, the electric motor disposed in a motor volume of the housing, the intermediate inlet being fluidly connected to the one or more of the inlet vanes via the motor volume, the motor volume configured to direct the intermediate working fluid in the motor volume across the electric motor to cool the electric motor.

6. The compressor of claim 5, further comprising:
an intermediate passageway fluidly connecting the motor volume to the inlet vanes, the intermediate passageway directing the intermediate working fluid in the motor volume, after passing across the electric motor, to the one or more of the inlet vanes.

7. The compressor of claim 1, further comprising:
a suction passageway fluidly connecting the suction inlet to an inlet of the impeller, the inlet vanes disposed in the suction passageway and configured to guide flow of the suction working fluid within the suction passageway.

8. The compressor of claim 7, wherein the inlet vanes are adjustable to change an angle of the inlet vanes within the suction passageway.

9. The compressor of claim 7, wherein the intermediate working fluid flows into the suction passageway through the one or more of the inlet vanes.

10. A heating, ventilation, air conditioning, and refrigeration (HVACR) system, comprising:
a refrigerant circuit including a compressor, a condenser, an expander, and an evaporator fluidly connected, the compressor including:
a housing including a suction inlet and an intermediate inlet,
an impeller disposed within the housing, the impeller configured to rotate relative to the housing to compress working fluid that includes suction working fluid from the suction inlet and intermediate working fluid from the intermediate inlet,
inlet vanes disposed between the suction inlet and the impeller, the inlet vanes configured to guide the suction working fluid flowing from the suction inlet to the impeller, one or more of the inlet vanes fluidly connected to the intermediate inlet and configured to discharge the intermediate working fluid into the suction working fluid flowing across the inlet vanes.

11. The HVACR system of claim 10, wherein the one or more of the inlet vanes includes a vane body having:
an inlet configured to receive the intermediate working fluid from the intermediate inlet, and
one or more openings configured to discharge the intermediate working fluid into the suction working fluid flowing across the inlet vanes.

12. The HVACR system of claim 11, wherein the vane body includes a downstream vane end and an upstream vane end opposite to the downstream vane end, the suction working fluid flows across the vane body from the upstream vane end to the downstream vane end, and the one or more openings are formed in the downstream vane end of the vane body.

13. The HVACR system of claim 10, wherein the impeller includes an inlet configured to receive a mixed flow of the suction working fluid and the intermediate working fluid, and the working fluid compressed by the impeller is discharged from the compressor through a discharge outlet in the housing.

14. The HVACR system of claim 10, wherein the compressor includes an electric motor configured to rotate the impeller, the electric motor disposed in a motor volume of the housing, the intermediate inlet being fluidly connected to the one or more of the inlet vanes via the motor volume, the motor volume configured to direct the intermediate working fluid in the motor volume across the electric motor to cool the electric motor.

15. The HVACR system of claim 14, wherein the compressor includes an intermediate passageway fluidly connecting the motor volume to the inlet vanes, the intermediate passageway directing the intermediate working fluid in the motor volume, after passing across the electric motor, to the one or more of the inlet vanes.

16. The HVACR system of claim 10, wherein the compressor includes a suction passageway fluidly connecting the suction inlet to an inlet of the impeller, the inlet vanes disposed in the suction passageway and configured to guide flow of the suction working fluid within the suction passageway.

17. The HVACR system of claim 16, wherein the inlet vanes are adjustable to change an angle of the inlet vanes within the suction passageway.

18. The HVACR system of claim 16, wherein the intermediate working fluid flows into the suction passageway through the one or more of the inlet vanes.

19. The HVACR system of claim 10, wherein the refrigerant circuit includes:
a main flow path that extends from the compressor, through the condenser, the expander, and the evaporator, and the compressor, the main flow path supplying the suction working fluid to the suction inlet of the compressor, and
an intermediate flow path extending from the main flow path to the intermediate inlet of the compressor, the intermediate flow path supplying the intermediate working fluid to the intermediate inlet of the compressor.

20. A method of operating a compressor, comprising:
suctioning a stream of suction working fluid from a suction inlet to an inlet of an impeller, which includes guiding, with inlet vanes, the flow of suction working fluid flowing from the suction inlet to the inlet of the compressor;
directing intermediate working fluid from an intermediate inlet to the inlet vanes; and
discharging intermediate working fluid from one or more of the inlet vanes into the flow of suction working fluid flowing across the inlet vanes.
